(19) United States
(12) Patent Application Publication
(10) Pub. No.: US 2011/0234552 A1
(43) Pub. Date: Sep. 29, 2011

(54) IMAGE DISPLAY APPARATUS

(75) Inventor: Yukio Araoka, Hiratsuka-shi (JP)

(73) Assignee: CANON KABUSHIKI KAISHA, Tokyo (JP)

(21) Appl. No.: 13/043,752

(22) Filed: Mar. 9, 2011

(30) Foreign Application Priority Data
Mar. 24, 2010 (JP) 2010-068436

(51) Int. Cl. G06F 3/038

(52) U.S. Cl. 345/204

(57) ABSTRACT

An image display apparatus comprises: a display panel; a row wiring drive circuit; and a column wiring drive circuit, wherein, the row wiring drive circuit includes: a selection signal output circuit which outputs a selection signal to a row wiring to be set to a selected state; a non-selection signal output circuit which outputs a non-selection signal to a row wiring to be set to a non-selected state; and an adjustment circuit which decreases an output impedance of the non-selection signal output circuit by feeding back a potential corresponding to a potential of the row wiring in the non-selected state.

### BACKGROUND OF THE INVENTION

1. Field of the Invention

The present invention relates to an image display apparatus, and particularly to an image display apparatus having a matrix panel used for monitors of TV receivers, computers and the like.

2. Description of the Related Art

Conventionally display apparatus using electron-emitting devices (electron beam display apparatuses), liquid crystal display apparatuses, plasma display apparatuses, organic EL display apparatuses, among others, have been used as image display apparatuses (flat image display apparatuses). This type of flat image display apparatus has a display panel on which a plurality of display elements are arrayed in a matrix (matrix panel) and a circuit for driving the lay elements. Various types of drive methods are used for driving the display elements depending on the display device, such as sequential line driving, hold driving and sub-field driving. A prior art on a method for driving non-selected row wiring (row wiring in non-selected state) in the sequential line driving is disclosed in Japanese Patent Application Laid-Open Nos. 2002-162927, H11-161223 and H8-202309, for example. In concrete terms, Japanese Patent Application Laid-Open Nos. 2002-162927 and H11-161223 disclose a technology on a method for decreasing the leak current of display element connected to non-selected row wiring, intended to decrease power consumption. Japanese Patent Application Laid-Open No. H8-202309 discloses a technology to clamp potential using a diode in order to suppress overshoot of a non-selection signal (a signal which is output to a row wiring to be set to a non-selected state). However generally speaking, non-selected row wirings are driven by a simple switch configuration shown by the reference mark 12b in FIG. 11, considering cost and circuit scale (FIG. 11 is a diagram depicting a conventional row wiring drive circuit).

The above mentioned conventional methods however have the following problems in image display performance.

That is, because of capacity coupling of an impedance of a switch for driving a non-selected row wiring and a crossing section of a row wiring and column wiring, the potential of a non-selected row wiring may fluctuate when an image is displayed, and this fluctuation transmits to the other selected row wirings and column wirings, deteriorating a display image. FIGS. 10A and 10B show examples of display images. FIGS. 6A and 65 are graphs depicting various drive waveforms when the images in FIGS. 10A and 105 are displayed. For example, in the case of displaying only a single color patch 10b shown in FIG. 10A, a column wiring drive waveform (waveform of modulation signal; potential waveform of a column wiring) for displaying this image is shown by the waveform 6h. If the single color patch 10b and a hand 10c having a lower gradation value than the single color patch 10b are displayed simultaneously, as shown in FIG. 105, the potential of a non-selected row wiring (waveform 6d) fluctuates influenced by the fall of the column wiring drive waveform (reference mark 6c in FIG. 6A) for displaying the band 10c. This fluctuation transmits to the potential of the column wiring corresponding to the single color patch lob, and the column wiring drive waveform for displaying the single color patch 10b has a distorted waveform, as shown by the reference mark 6f. As a result, the desired waveform (waveform 6h) cannot be obtained, and the display image deteriorates.

In the case of the technology disclosed in Japanese Patent Application Laid-Open No. 2002-162927, the impedance of the non-selected row wirings increases, so the potential fluctuation of non-selected row wirings is aggravated, and displayed images deteriorate. In the case of the technology disclosed in Japanese Patent Application Laid-Open No. H11-161223, the leak current of the display elements can be suppressed, but potential fluctuation due to the above mentioned capacity coupling cannot be suppressed, therefore image display performance cannot be improved. In the case of the technology disclosed in Japanese Patent Application Laid-Open No. H8-202309, only an overshoot exceeding the clamp potential can be suppressed, and the effect of suppressing potential fluctuation below the clamp potential involving an undershoot is minor and the potential specification is vague, so a display image sometimes deteriorates.

### SUMMARY OF THE INVENTION

The present invention provides a technology to improve image display performance.

An image display apparatus according to the present invention, comprises:

a display panel on which a plurality of display elements are disposed in a matrix using a plurality of row wirings and a plurality of column wirings;

a row wiring drive circuit which sequentially selects a plurality of row wirings; and

a column wiring drive circuit which outputs a modulation signal, obtained by modulation based on a video signal being input, to the plurality of column wirings,

wherein

the row wiring drive circuit includes:

a selection signal output circuit which outputs a selection signal to a row wiring to be set to a selected state;

a non-selection signal output circuit which outputs a non-selection signal to a row wiring to be set to a non-selected state; and

an adjustment circuit which decreases an output impedance of the non-selection signal output circuit by feeding hack a potential corresponding to a potential of the row wiring in the non-selected state.

According to the present invention, image display performance can be improved.

Further features of the present invention will become apparent from the following description of exemplary embodiments with reference to the attached drawings.

### BRIEF DESCRIPTION OF THE DRAWINGS

FIG. 1 is a diagram depicting an example of a row wiring drive circuit according to Example 1;

FIG. 2 is a diagram depicting an example of a configuration of an image display apparatus according to the present embodiment;

FIG. 3 is a diagram depicting an example of drive waveforms in a sequential line driving;

FIG. 4 is a diagram depicting an example of row wiring drive circuit according to the present embodiment;

FIG. 5 is a diagram depicting an example of connection mode of a row wiring drive circuit and a row wiring;

FIGS. 6A and 6B are graphs depicting a problem and effect of the present invention;

FIG. 7 is a diagram depicting an example of a row wiring drive circuit according to Example 2;

FIG. 8 is a diagram depicting an example of a row wiring drive circuit according to Example 3;

FIGS. 9A and 9B are diagrams depicting an example of a row wiring drive circuit according to Example 4;

FIGS. 10A and 10B are diagrams depicting examples of display images; and

FIG. 11 is a diagram depicting a conventional row wiring drive circuit.

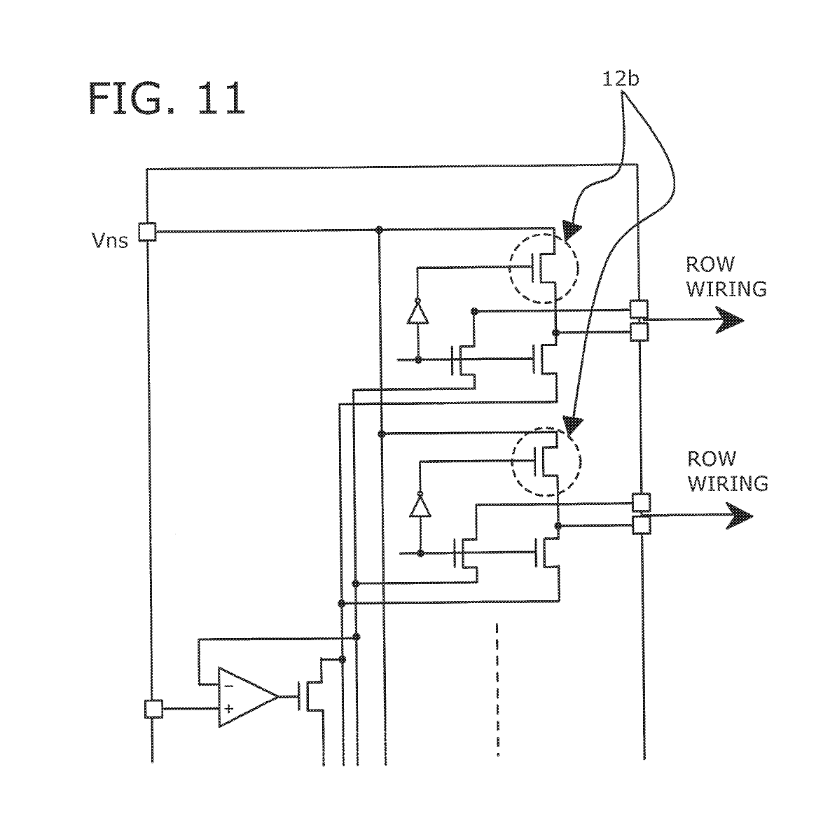

### DESCRIPTION OF THE EMBODIMENTS

An image display apparatus according to the present embodiment will now be described.

The image display apparatus according to the present embodiment has a display panel (matrix panel) on which a plurality of display elements are disposed in a matrix using a plurality of row wirings and a plurality of column wirings. The present invention can be applied to an electron beam display apparatus, liquid crystal display apparatus, plasma display apparatus and organic EL display apparatus, for example. In particular, an electron beam display apparatus is a most preferable embodiment of the present invention, since wiring capacity of the matrix panel and capacity of the electron-emitting element portion are large, and an improvement of image display performance by sequential line driving, which is an effect of the present invention, can be especially expected. For the electron beam display apparatus, cold cathode devices, such as FE electron-emitting devices, MIM electron-emitting devices and surface conduction electron-emitting devices are used as display elements.

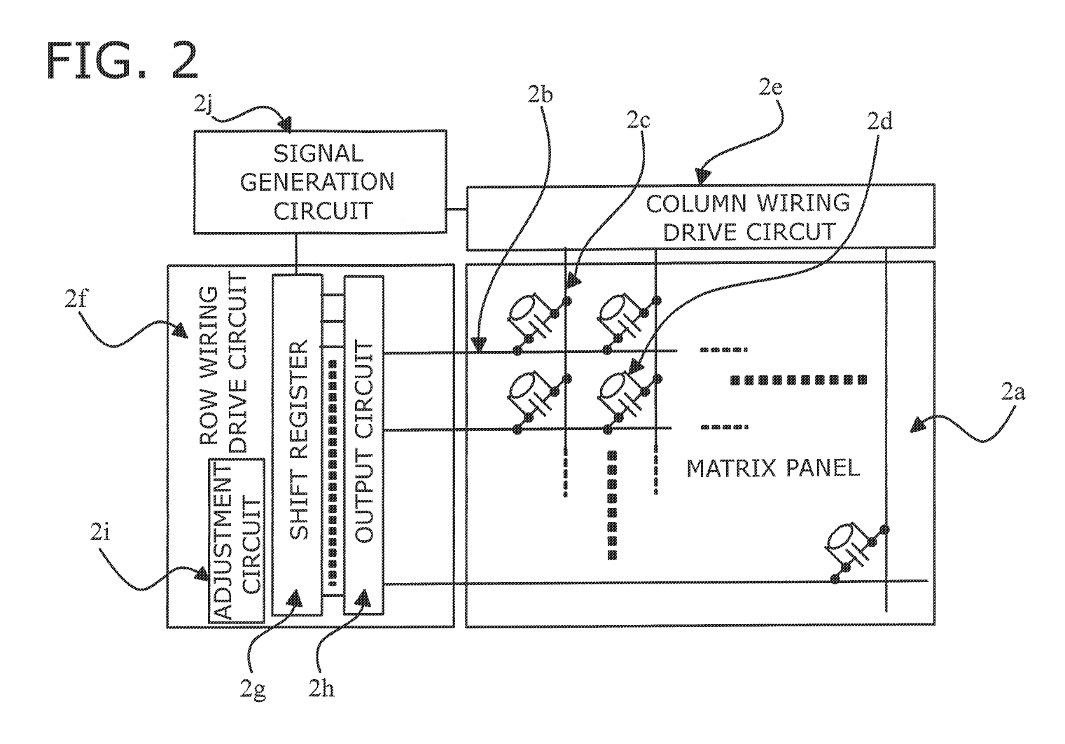

FIG. 2 is a diagram depicting an example of a configuration of the image display apparatus according to the present embodiment. As FIG. 2 shows, the image display apparatus according to the present embodiment has a display panel 2a, a row wiring drive circuit 2f, a column wiring drive circuit 2e and a signal generation circuit 2j among others.

The display panel 2a has a plurality of row wirings 2b, a plurality of column wirings 2c and a plurality of display elements 2d.

The signal generation circuit 2j outputs a video signal to the column wiring drive circuit 2e, and outputs a horizontal synchronization signal to the row wiring drive circuit 2f.

The column wiring drive circuit outputs a modulation signal, which is obtained by modulation based on a video signal being input, to a plurality of column wirings 2c. In concrete terms, the column wiring drive circuit modulates a pulse width and pulse height value of the modulation signal based on the video signal.

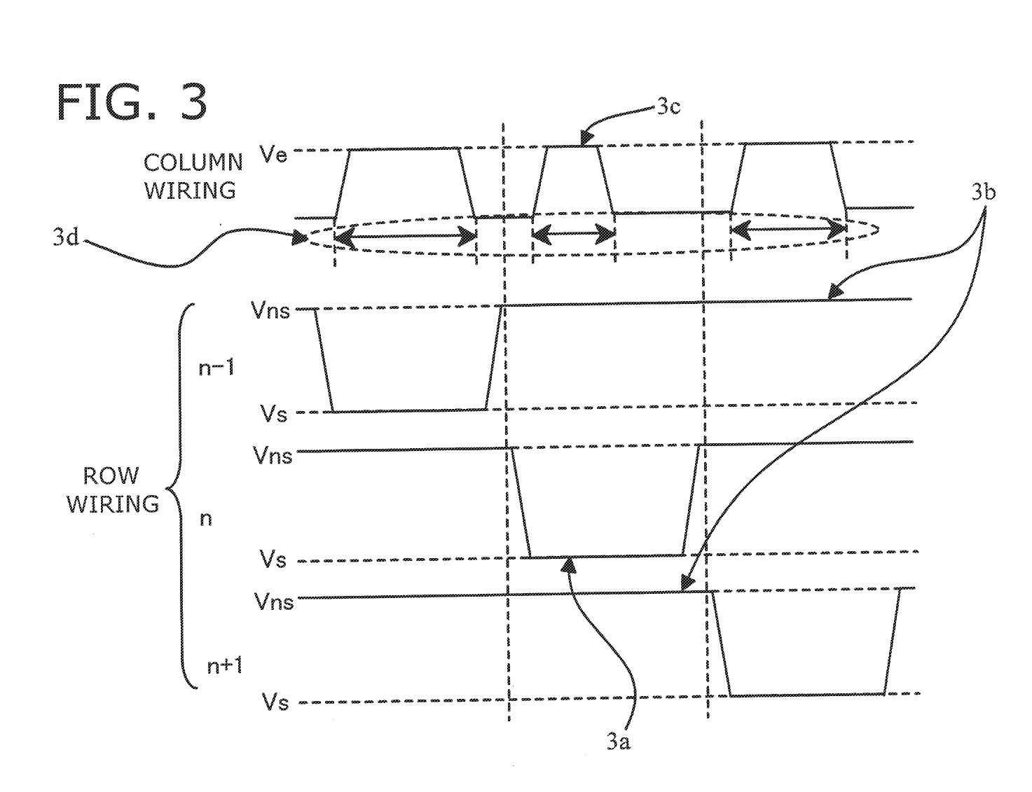

The row wiring drive circuit 2f sequentially selects a plurality of row wirings 2b. For example, the row wiring drive circuit 2f has a shift register 2g and output circuit 2h (multiplexer) among others. The output circuit 2h has a selection signal output circuit which outputs a selection signal (selection potential Vs) to a row wiring to be set to the selected state, and a non-selection signal output circuit which outputs a non-selection signal (non-selection potential Vns) to a row wiring to be set to the non-selected state. The non-selection signal output circuit and the selection signal output circuit are circuits using bipolar transistors and CMOS transistors. The row wiring drive circuit 2f sequentially selects row wirings synchronizing with the output of the modulation signal (drive potential Ve) to a column wiring as shown in FIG. 3. FIG. 3 is a diagram depicting an example of the drive waveforms in the sequential line driving.

In concrete terms, the shift register 2g generates a control signal for sequential line driving from a horizontal synchronization signal which is input. Then the output circuit 2h sequentially switches a state of the row wirings to a selected state or non-selected state according to this control signal (synchronizing with applying the modulation signal to the column wirings). In other words, a circuit to be used for a row wiring is switched between the selection signal output circuit and the non-selection signal output circuit. Thereby a selection signal to set a row wiring to a selected state is output, and a non-selection signal to set a row wiring to a non-selected state is output from the output circuit 2h. And the display elements connected to the selected row wirings are driven according to the modulation signal (in other words, the display elements are driven by the row wiring drive circuit 2f and the column wiring drive circuit 2e).

In the present embodiment, the row wiring drive circuit 2f has an adjustment circuit 2i for decreasing the output impedance of the non-selection signal output circuit (output impedance of the non-selection signal to display elements) by feeding back a potential corresponding to the potential of the row wirings in a non-selected state.

Since the output impedance of the non-selection signal output circuit in a conventional switch configuration is about 10Ω per output (one row wiring), it is preferable that the adjustment circuit 2i adjusts the output impedance of the non-selection signal output circuit to be 10Ω or less.

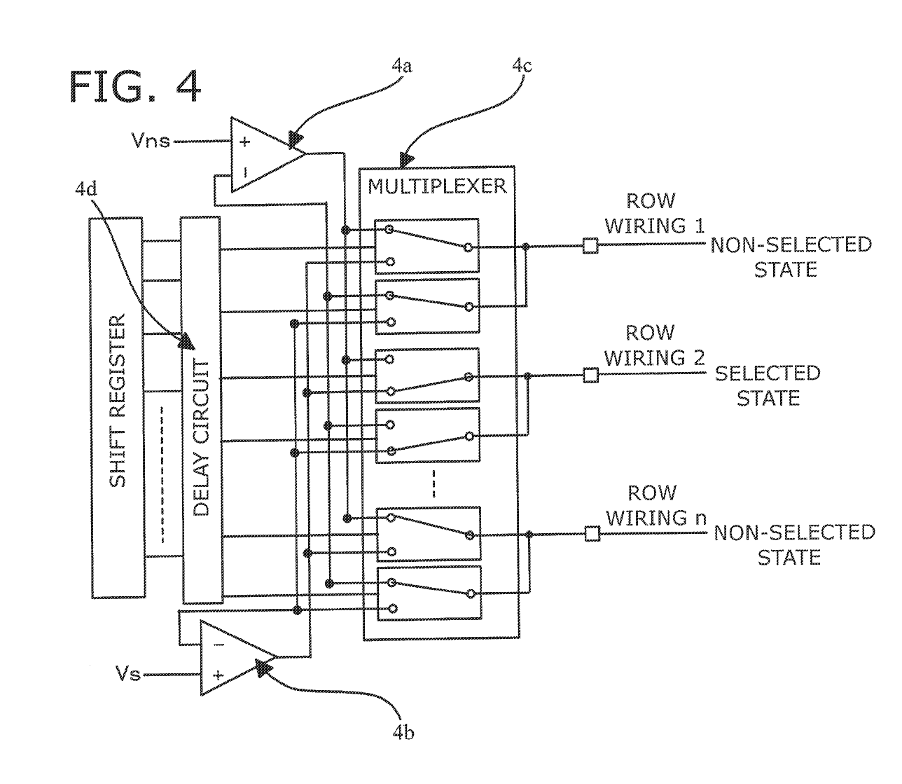

FIG. 4 is a diagram depicting an example of the row wiring drive circuit according to the present embodiment. As the reference symbol 4a in FIG. 4 shows, it is preferable that the adjustment circuit 2i is a circuit having an inverting amplifier which feeds back a potential corresponding to the potential of a row wiring in the non-selected state, so as to approach this potential to a predetermined potential. If such an inverting amplifier is used, a reduction in circuit scale can be expected.

As shown in FIG. 4, if an inverting amplifier (inverting amplifier 4b) is used for driving a row wiring to be selected as well, it is preferable that the inverting amplifiers 4a and 4b are separate units, and the inverting amplifier to be used can be switched by the multiplexer 4c.

The inverting amplifier 4a can be disposed for each row wiring, but it is preferable that one inverting amplifier 4a is disposed for a plurality of row wirings. In concrete terms, it is preferable that the adjustment circuit 2i outputs a non-selection signal, which is output to a plurality of row wirings to be set to a non-selected state, from the inverting amplifier 4a to each non-selection signal output circuit, and feeds back a composite potential of each potential corresponding to the potential of each row wiring in a non-selected state, to the inverting amplifier 4a. By this configuration, the circuits can be simplified.

If a state of a row wiring is switched from the selected state to the non-selected state, noise may be generated in the potential of the row wiring switched to the non-selected state. If such a potential is fed back in a configuration using one inverting amplifier 4a for a plurality of row wirings, the noise may affect the non-selection signals to be output to the other non-selected row wirings. Therefore it is preferable that the row wiring drive circuit 2f has a delay circuit 4d, as shown in FIG. 4. When the state of a row wiring is switched from the selected, state to the non-selected state, the delay circuit 4d delays the timing to start feeding back the potential corresponding to the potential of the row wiring switched to the non-selected state from the switching timing.

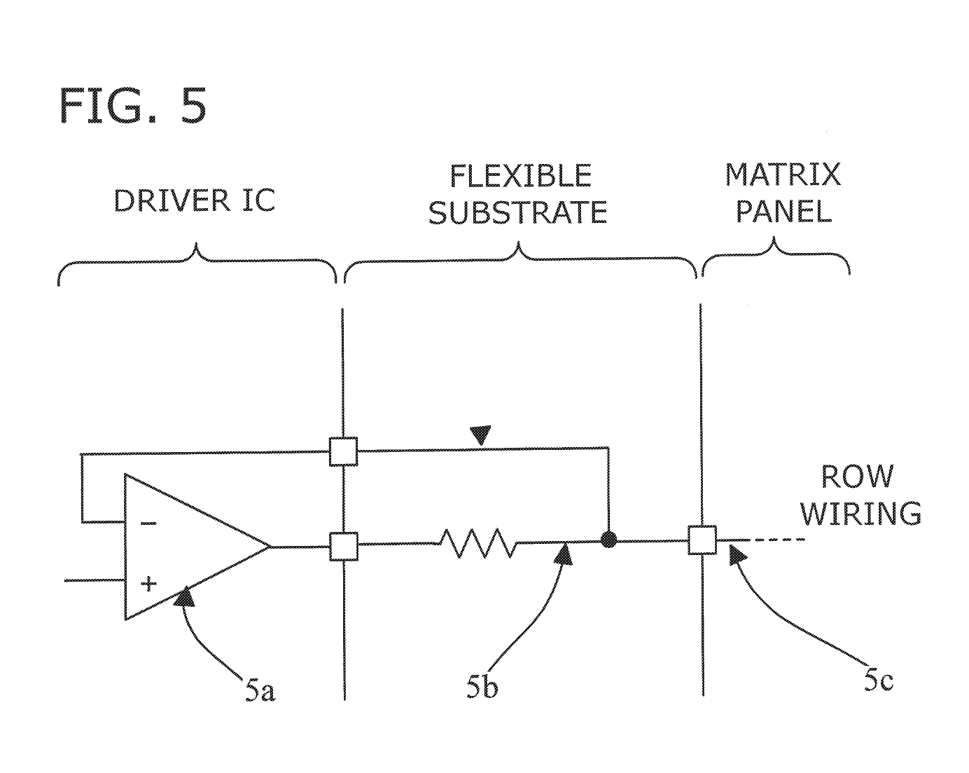

It is preferable that the potential to be fed back to the inverting amplifier 4a is the potential at a position close to the display element. FIG. 5 is a diagram depicting an example of a connection mode of the row wiring drive circuit and a row wiring. In concrete terms in FIG. 5, a driver IC having the non-selection signal output circuit and the adjustment circuit (inverting amplifier 5a) is connected to the row wiring 5c via a wiring (lead) 5b on a flexible substrate, such as TOP (tape carrier package) and COF (chip on film). In the case of this configuration, the potential on the wiring 5b and the row wiring 5c can be fed back to the inverting amplifier 5a. As the position of the potential to be fed back is closer to the display element, controllability (stability) of the non-selection signal can be increased.

It is preferable that a part of the circuit (feedback loop), which is used when a potential is fed back to the inverting amplifier 4a and a part of the feedback loop for feeding hack the potential to the inverting amplifier 4b, are a common circuit as shown in FIG. 4. By this configuration, the circuits can be further simplified.

### Example 1

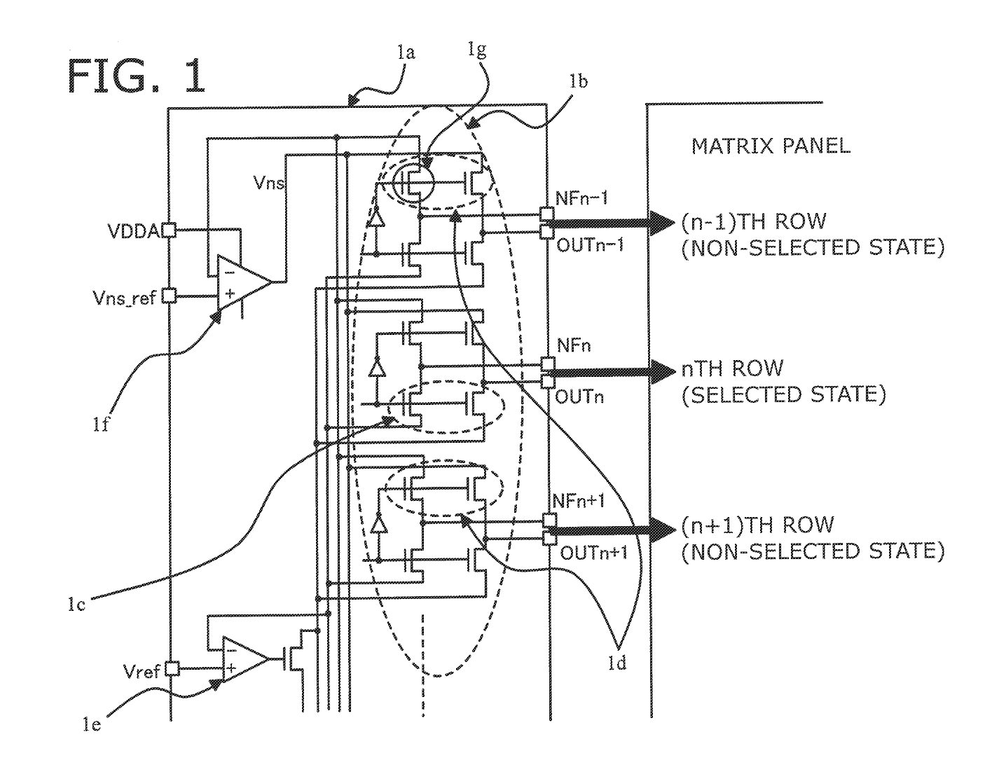

An image display apparatus according to Example 1 of the present invention will be described. A general configuration of the image display apparatus according to this example is the same as FIG. 2, so the description thereof is omitted, and a concrete configuration of the row-wiring drive circuit will be described below with reference to FIGS. 1 and 3. FIG. 1 is a diagram depicting an example of the row wiring drive circuit according to this example. In FIG. 1, the shift register is omitted.

In FIG. 1, reference mark 1a denotes a row wiring drive circuit, 1b denotes an output circuit (multiplexer), 1c denotes a selection side switching circuit, 1d denotes a non-selection side switching circuit, 1e denotes selection side inverting amplifier, 1f denotes a non-selection side inverting amplifier, and 1a denotes a switch. In concrete terms, the selection side inverting amplifier 1e is an inverting amplifier for outputting a selection signal to the selection signal output circuit, and the non-selection side inverting amplifier 1f is an inverting amplifier for outputting a non-selection signal to the non-selection signal output circuit. The selection side switching circuit 1c is constituted by a switch (selection signal output circuit) for outputting the selection signal to a row wiring, and a switch for feeding back a potential corresponding to the potential of the row wiring (row wiring in the selected state) to the selection side inverting amplifier 1e. The non-selection side switching circuit 1d is constituted by a switch (non-selection signal output circuit) for outputting a non-selection signal to a row wiring, and a switch 1g for feeding back a potential corresponding to the potential of the row wiring (row wiring in the non-selected state) to the non-selection side inverting amplifier 1f. In other words, according to this example, the adjustment circuit is constituted by the non-selection side inverting amplifier 1f and the switch 1g. As FIG. 1 shows, according to this example, one non-selection side inverting amplifier 1f is used for a plurality of row wirings. Also a common circuit is used for a part of the feedback loop for the selection side inverting amplifier 1e and a part of the feedback loop for the non-selection side inverting amplifier 1f. Thereby the circuits can be simplified.

Now an operation in the case of driving the n-th electron-emitting device (electron-emitting device connected to the row wiring in the n-th row) out of a plurality of electron-emitting devices disposed in a matrix in FIG. 1 will be described as an example.

In this case, two switches in the selection side switching circuit 1c in the n-th row (selection side switching circuit connected to the row wiring in the n-th row) are turned ON by a control signal from the shift register. Thereby the selection signal 3a (selection potential Vs) is output to the row wiring in the n-th row.

A non-selection signal 3b (non-selection potential Vns) is output to the other row wirings in the (n−1)th and (n+1)th rows by the two switches in the non-selection side switching circuit 1d turning ON. This operation is performed for all the row wirings to be set to a non-selected state.

Each of the above mentioned switches is turned ON at the same timing.

Synchronizing with the above processing (output of selection signal and non-selection signal), a modulation signal 3c (drive potential Ve) is output to the column wirings based on the video signal.

According to this method, voltage Ve−Vs (≧Vth (electron emission threshold: voltage required for emitting electrons)) is applied, to an electron-emitting device connected to a selected row wiring, and voltage Ve−Vns (<Vth) is applied to an electron-emitting device connected to a non-selected row wiring.

In order to output an electron-beam having a desired intensity from an electron-emitting device, the values of Ve, Vs and Vns are set to the appropriate values.

Since the response speed of the cold cathode device is fast, the duration of the output time of the electron beam can be changed if the duration of time of applying the drive potential Ve (pulse width indicated by the arrow mark 3d in FIG. 3) is changed.

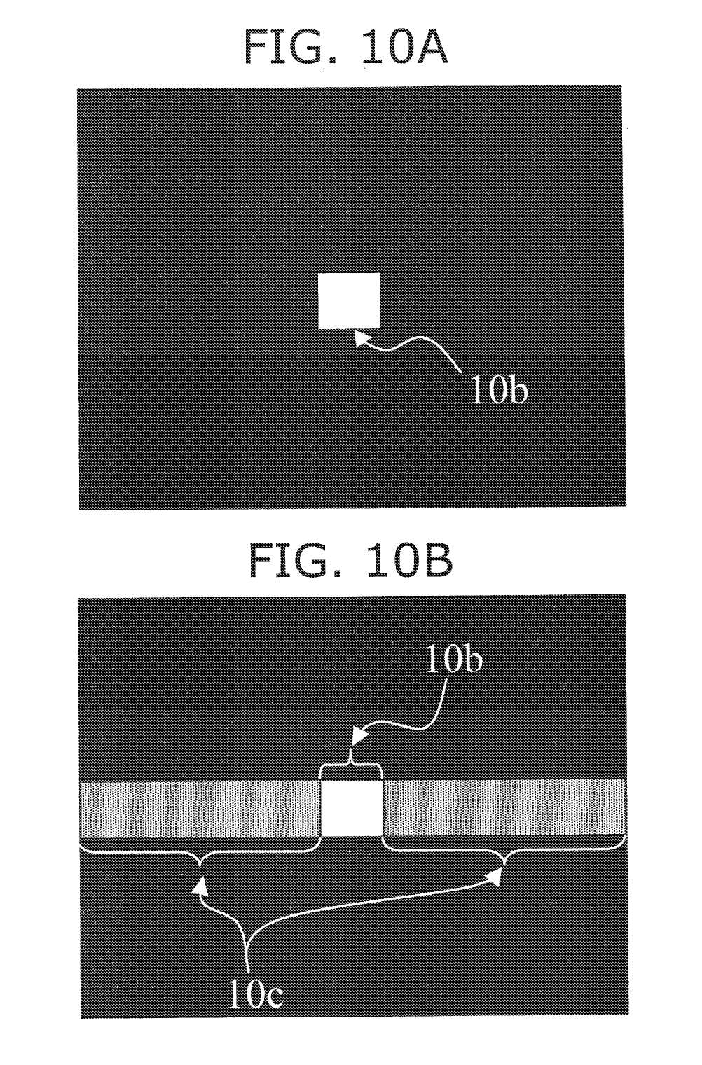

Assuming the above configuration, the drive waveforms when the images (display patterns) in FIGS. 10A and 105 are displayed were calculated by simulation.

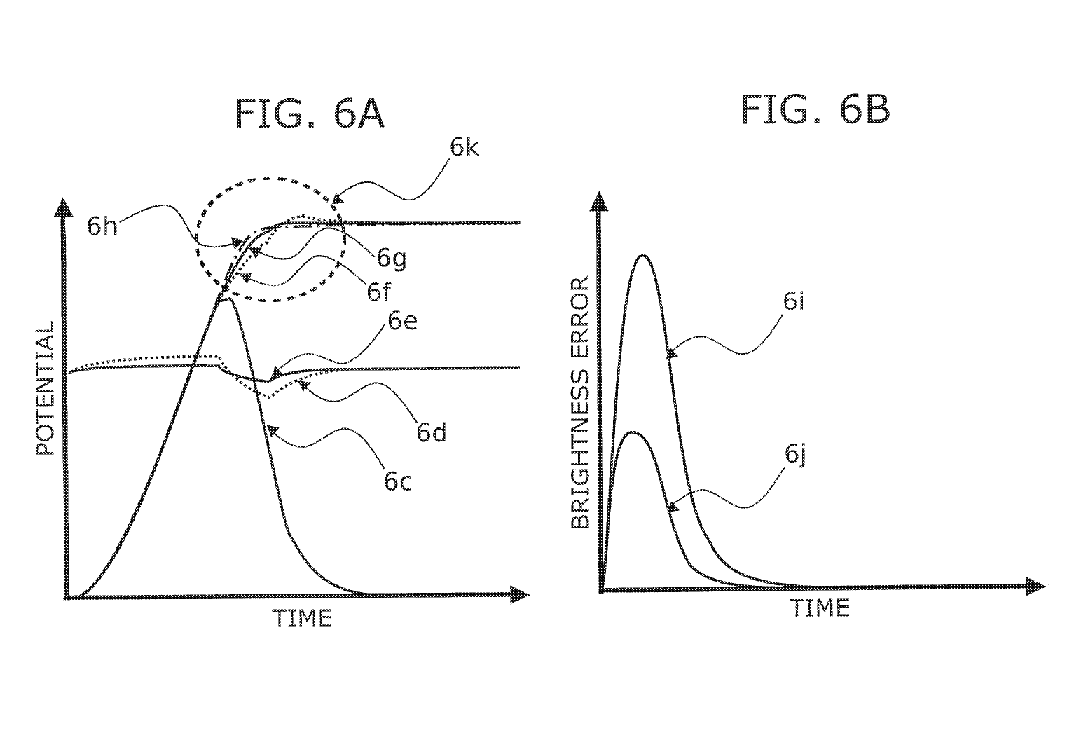

As the result in FIG. 6A shows, fluctuation of the potential of the non-selected row wiring (waveform 6d) which is caused in the prior art by the fall of the column wiring drive waveform 6c for displaying the band 10c, can be suppressed in this example. In concrete terms, the fluctuation of the potential of the non-selected row wiring can be decreased compared with the fluctuation of the waveform 6d, as indicated by the waveform 6e. Thereby the fluctuation of the column wiring drive waveform corresponding to the single color patch 10b can also be suppressed. Specifically, the column wiring drive waveform corresponding to the single color patch 10b, of which waveform is 6f in the prior art, can be improved to be the waveform 6g in this example, which is closer to the waveform 6h, that is a waveform in an ideal drive state.

Then deviation values of the waveforms 6q and 6f, in a portion where fluctuation of the potential is generated (portion indicated by the reference mark 6k, in FIG. 6A) from the waveform 6h, were converted into brightness values. The result is shown in FIG. 6B. The reference mark 6i denotes a value of deviation of the waveform 6f (waveform of prior art) from the waveform 6h, which is converted into a brightness value (brightness error), and a reference mark 6j denotes a value of deviation of the waveform 6g (waveform of this example) from the waveform 6h, which is converted into a brightness value. As FIG. 6B shows, the brightness error is decreased in this example compared with the prior art (brightness error 6i). This means that the image display performance is improved by the configuration of this example.

As described above, according to this example, the potential corresponding to the potential of a row wiring in the non-selected state is fed, back to the non-selection side inverting amplifier, whereby this potential becomes closer to a predetermined potential, and the output impedance of the non-selection signal output circuit is decreased. As a result, fluctuation of the potential of the non-selection signal can be suppressed, and the image display performance can be improved.

### Example 2

In this example, a case, when the non-selection signal output circuit is a circuit embedded in an IC and the non-selection side inverting amplifier is an external component of the IC, will be described. In concrete terms, a case of disposing the non-selection side inverting amplification circuit inside and outside a semiconductor IC will be described.

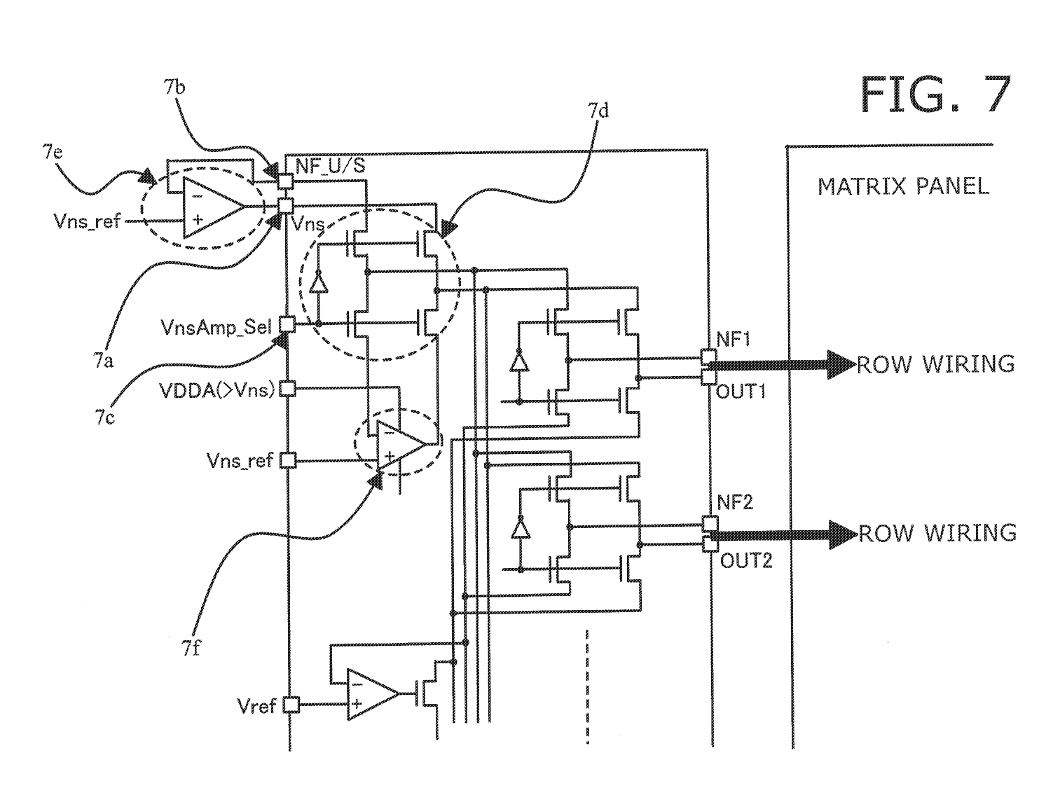

FIG. 7 is a diagram depicting an example of a row wiring drive circuit according to this example. As shown in FIG. 7, the row wiring drive circuit according to this example has external terminals 7a, 7b and 7c, and a selection circuit 7d in addition to the configuration in FIG. 2. The external terminal 7a is a terminal for externally inputting a non-selection signal to the non-selection signal output circuit, and is a terminal to which an output terminal, of non-selection side inverting amplifier (external inverting amplifier 7e), which is an external component, is connected. The external terminal 7b is an external terminal 7h for outputting the potential to be fed hack (potential corresponding to the potential of a row wiring in the non-selected state) to the outside, and is a terminal which is connected to an inverting input terminal of the external inverting amplifier 7e. The external terminal 7c is a terminal for inputting a selection signal for determining which of the external inverting amplifier 7e and the non-selection side inverting amplifier 7f embedded in the semiconductor IC is used as the non-selection side inverting amplifier. The selection circuit 7d is a circuit for switching a non-selection side inverting amplifier according to the selection signal.

According to this example, a non-selection side inverting amplifier can easily be changed when a high performance (high band) external inverting amplifier can be selected by using an external component as the non-selection side inverting amplifier. By this modification, high image quality (improvement of image display performance) can be expected.

### Example 3

In this example, a case of a non-selection signal output circuit and a selection signal output circuit outputting a non-selection signal and a selection signal respectively via a lead formed on a flexible substrate will be described. Generally a plurality of leads corresponding to a plurality of row wirings are formed on such a flexible substrate. The plurality of leads have a diagonal wiring portion in which intervals between the respective leads increase toward the row wiring side.

According to this example, the adjustment circuit feeds back the potential at a position closer to the row wiring side than the diagonal wiring portion, to the non-selection side inverting amplifier and selection side inverting amplifier.

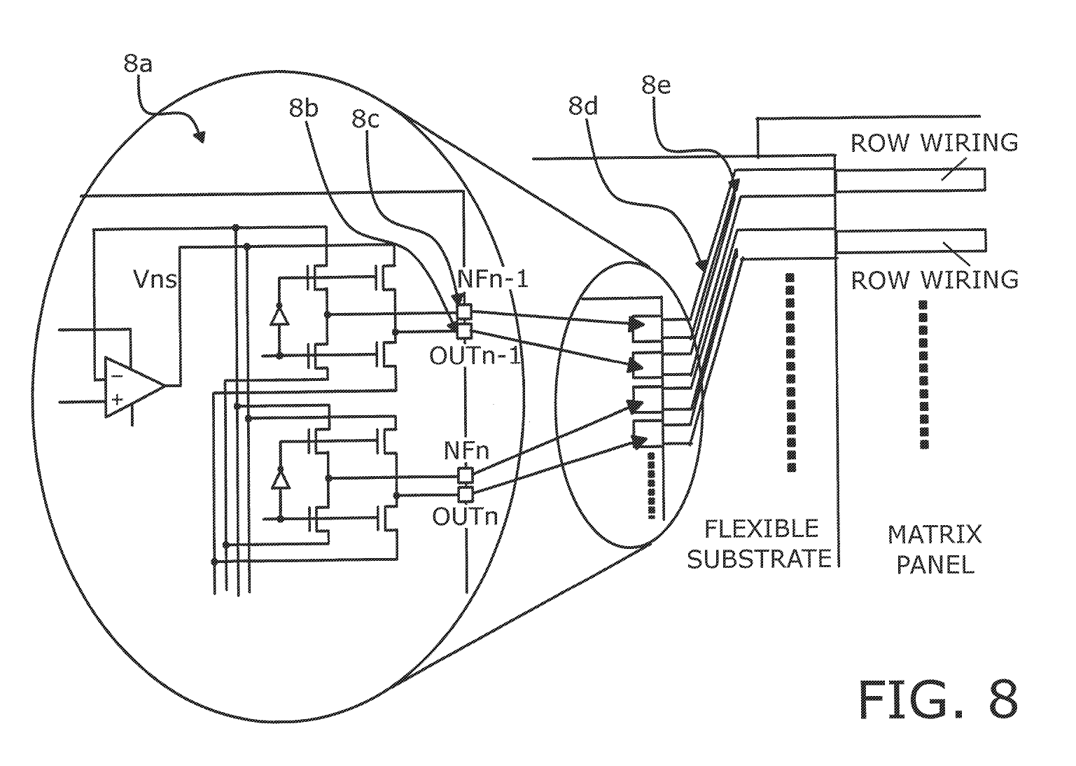

In concrete terms, as FIG. 8 shows, an output terminal 8b of a row wiring drive circuit 8a and an input terminal 8c, to which a potential to be fed back is input, are disposed for each row wiring (FIG. 8 is a diagram depicting an example of the row wiring drive circuit according to this example). And a feedback loop is created so that a potential at the position 8e closer to the row wiring side than the diagonal wiring portion 8d on the film package is fed back. In other words, the position 8e is a start point of the feedback loop. The rest of the configuration is the same as Examples 1 and 2, therefore description thereof is omitted.

According to this example, the potential at a position closer to the row wiring side than the diagonal wiring portion 8d is fed back to the non-section side inverting amplifier, therefore controllability (stability) of the non-selection signal can be improved compared with the case of feeding back a potential at a position immediately after output in the non-selection side inverting amplifier.

In the above mentioned diagonal wiring portion, a difference is generated in the length (wiring resistance) between each wiring (lead), so a difference is generated in the amount of drop in potential, and a display unevenness is generated in the film package (flexible substrate) unit. According to this example, the non-selection side inverting amplifier and the selection side inverting amplifier share the circuit from the start point of the feedback loop to the shift register, so the above mentioned display unevenness can be prevented. In other words, the display unevenness can be prevented because the potential at a position closer to the row wiring side than the diagonal wiring portion 8d is also fed back to the selection side inverting amplifier.

### Example 4

According to the configuration of this example to be described below, when the state of the row wiring is switched from the selected state to the non-selected state, the timing to start feeding back the potential corresponding to the potential of the row wiring switched to the non-selected state is delayed from this switching timing. In concrete terms, in this example, a configuration of the adjustment circuit having a delay circuit for performing such delay will be described. The rest of the configuration is the same as Examples 1 to 3. In this example, it is assumed that one non-selection side inverting amplifier is used for a plurality of row wirings.

When the state of the row wiring is switched from the selected state to the non-selected state, such a negative influence as noise may be generated on the non-selection signal to be output to the other non-selected row wirings, if the potential corresponding to the potential of the row wiring switched to the non-selected state is fed back without delay.

According to this example, feedback of intermediate potential (potential including noise) in the middle of transition of the row wiring from the selected state to the non-selected state can be suppressed by using the above configuration. For the potential corresponding to the potential of the row wiring in the middle of transition from the selected state to the non-selected state, only the potential corresponding to the potential of the other non-selected row wirings is fed back to the non-selection side inverting amplification circuit, so a constant non-selection potential is targeted (temporal switch driving). As a result, it is obvious that stable operation can be performed even in the transition from the selected state to the non-selected state.

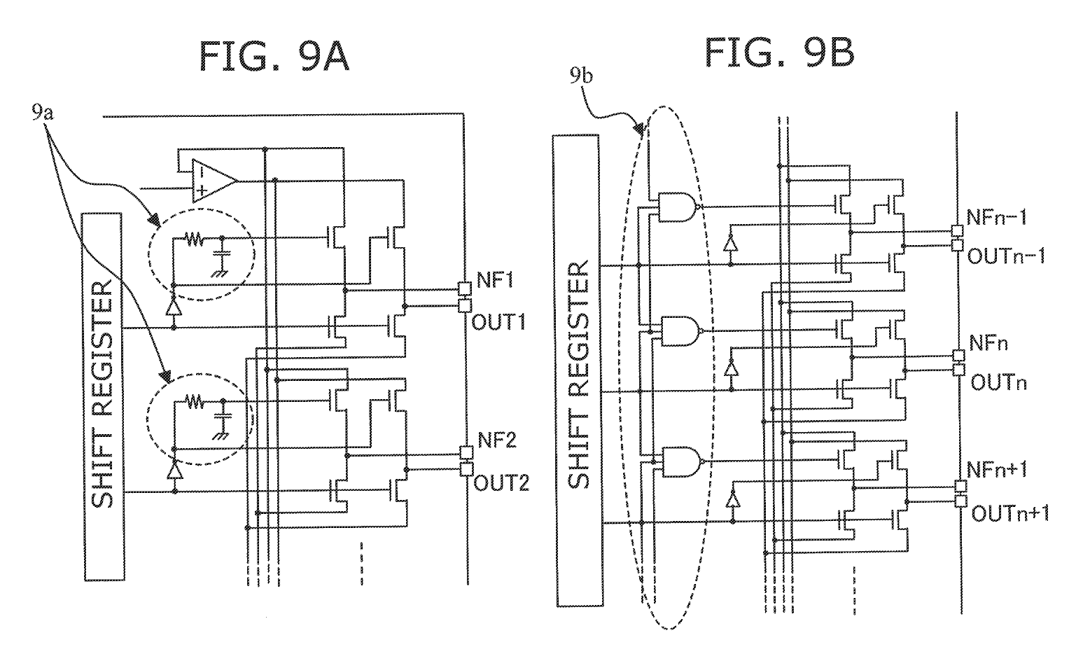

FIG. 9A and FIG. 9B are diagrams depicting examples of a row wiring drive circuit according to this example. The above mentioned configuration is implemented by disposing a delay circuit, using an active element or passive element (e.g. RC integration circuit (reference mark 9a in FIG. 9A)), in front of a switch for conducting the feedback loop for the non-selection side inverting amplifier. This delay circuit may be a logic circuit which inverts the logic after the potential of the row wiring, which is shifted from the selected state to the non-selected state, is sufficiently stabilized, so that the feedback loop for feeding back the potential corresponding to this potential to the non-selection side inverting amplifier is logically conducted. For example, as FIG. 9B shows, a three NAND logic circuit 9b, which inverts logic after the non-selected state is confirmed for this row wiring and one row wiring before and one row wiring after this row wiring, may be used for each row wiring. As long as feedback of the intermediate potential can be suppressed, the number of row wirings for which the state is checked can be arbitrary.

As described above, according to the image display apparatus according to this embodiment, the output impedance of the non-selection signal output circuit can be decreased by feeding back the potential corresponding to the potential of the row wiring in the non-selected state. Thereby fluctuation of potential of the non-selection signal can be suppressed, and image display performance can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-068436, filed on Mar. 24, 2010, which is hereby incorporated by reference herein in its entirety.

What is claimed is:

1. An image display apparatus, comprising:
display panel on which a plurality of display elements are disposed in a matrix using a plurality of row wirings and a plurality of column wirings;
a row wiring drive circuit which sequentially selects a plurality of row wirings; and
a column wiring drive circuit which outputs modulation signal, obtained by modulation based on a video signal being input, to the plurality of column wirings, wherein
the row wiring drive circuit includes:
a selection signal output circuit which outputs a selection signal to a row wiring to be set to a selected state;
a non-selection signal output circuit which outputs a non-selection signal to a row wiring to be set to a non-selected state; and
an adjustment circuit which decreases an output impedance of the non-selection signal output circuit by feeding back a potential corresponding to a potential of the row wiring in the non-selected state.

2. The image display apparatus according to claim 1, wherein
the adjustment circuit includes an inverting amplifier which feeds back a potential corresponding to the potential of the row wiring in the non-selected state, so as to bring the potential close to a predetermined potential.

3. The image display apparatus according to claim 2, wherein
the inverting amplifier is disposed singly for the plurality of row wirings, and
the adjustment circuit feeds back a composite potential of the potential of each row wiring in the non-selected state, to the inverting amplifier.

4. The image display apparatus according to claim 3, wherein
the adjustment circuit includes a delay circuit which, when the state of a row wiring is switched from a selected state to a non-selected state, delays a timing to start feedback of the potential corresponding to the potential of the row wiring switched to the non-selected state, from a timing of the switching.

5. The image display apparatus according to claim 2, wherein
the non-selection signal output circuit outputs a non-selection signal to the row wiring via, a lead formed on a flexible substrate,
a plurality of leads corresponding to the plurality of row wirings are formed on the flexible substrate,
the plurality of leads have a diagonal wiring portion in which intervals between the respective leads increase toward the row wiring side, and
the adjustment circuit feeds back a potential at a position closer to the row wiring side than the diagonal wiring portion, to the inverting amplifier.

6. The image display apparatus according to claim 2, wherein
the non-selection signal output circuit is a circuit embedded in an IC, and
the inverting amplifier is an external component of the IC.

7. The image display apparatus according to claim 1, wherein the adjustment circuit sets the output impedance to 10Ω or less.
